(19) United States
(12) Patent Application Publication
(10) Pub. No.: US 2023/0185594 A1
(43) Pub. Date: Jun. 15, 2023

(54) METRIC COLLECTION FROM A CONTAINER ORCHESTRATION SYSTEM

(71) Applicant: VMWARE, INC., Palo Alto, CA (US)

(72) Inventors: SHYAM KASI VENKATRAM, Bangalore (IN); MADHAN SANKAR, Bangalore (IN); AYUSHI GHATT, Bhopal (IN); PUNITH SOMASHEKAR, Bangalore (IN); GOPALKRISHNAN TANJORE SRINIVASAN, Bangalore (IN)

(21) Appl. No.: 17/592,545

(22) Filed: Feb. 4, 2022

(30) Foreign Application Priority Data
Dec. 13, 2021 (IN) 202141058013

(51) Int. Cl. G06F 9/455; G06F 9/445; G06F 16/2455; G06F 16/248

(52) U.S. Cl. CPC G06F 9/45558; G06F 9/45545; G06F 9/44505; G06F 16/2455; G06F 16/248; G06F 2009/45595; G06F 2009/45591

(57) ABSTRACT

a mapping can be maintained that maps a plurality of types of service instances provided by a container orchestration system to a first plurality of labels utilized by a first metric exporter and a second plurality of labels utilized by a second metric exporter to identify the plurality of types of service instances. A first query for a metric associated with a particular service instance and exported by the first metric exporter can be communicated. A second query for the metric associated with the particular service instance and exported by the second metric exporter can be communicated. The first and second queries can respectively include the labels utilized by the first and second metric exporters.

### RELATED APPLICATION

Benefit is claimed under 35 U.S.C. 119(a)-(d) to Foreign Application Serial No. 202141058013 filed in India entitled “METRIC COLLECTION FROM A CONTAINER ORCHESTRATION SYSTEM”, on Dec. 13, 2021, by VMware, Inc., which is herein incorporated in its entirety by reference for all purposes.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

VCIs can be used to provide the enterprise's applications. Such applications may be made up of one or more services. Metrics can be collected for these services and sent to a monitoring platform for display (e.g., using one or more dashboards). However, in addition to other limitations, current approaches to collecting metrics may be limited to particular metric exporters.

### BRIEF DESCRIPTION OF THE DRAWINGS

FIG. 1A is a diagram of an example of a container orchestration as an application in a system for metric collection from a container orchestration system in accordance with a number of embodiments of the present disclosure.

FIG. 1B is a diagram of an example of integrated container orchestration in a system 101 for metric collection from a container orchestration system in accordance with a number of embodiments of the present disclosure.

FIG. 2 is a block diagram illustrating an example system for metric collection from a container orchestration system in accordance with a number of embodiments of the present disclosure.

FIG. 3 is a diagram of a system for metric collection from a container orchestration system according to one or more embodiments of the present disclosure.

FIG. 4 is a diagram of a machine for metric collection from a container orchestration system according to one or more embodiments of the present disclosure.

FIG. 5 illustrates a method of metric collection from a container orchestration system according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes (which may be referred to herein simply as “nodes”). Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use namespaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

Services, as used herein, refers to services provided by a container orchestration system (e.g., nodes, pods, containers, namespaces, etc.). Particular instances of services may be referred to herein as “service instances.” “Types of service instances” or “service instance types” may alternately refer generally to “services.” An example of a service instance may be a particular container, “container 8j 809fsjag” of the service instance type “container.” A container orchestration system can manage multiple applications with shared services between the applications. A container orchestration system can be responsible for application deployment, scaling, and management, such as maintenance and updates of the applications and/or services. One example of a container orchestration system is Kubernetes, however, embodiments of the present disclosure are not so limited. The container orchestration system can manage a container cluster (sometimes referred to herein simply as “cluster”).

Metrics can be collected for services and sent to a monitoring platform for display (e.g., using one or more dashboards). A monitoring platform can deliver operations management with application-to-storage visibility across physical, virtual, and cloud infrastructures. One example of a monitoring platform is vRealize Operations (vROps), though embodiments of the present disclosure are not so limited. A monitoring platform can identify issues in a cluster using collected metrics, for instance. In some cases, metrics can be collected by one or more metrics exporters (sometimes referred to herein simply as “exporters” and sent to a metrics store. A metrics store, as referred to herein, is a systems and service monitoring system. In some embodiments, a metrics store is an open-source systems and service monitoring system. One example of a metrics store is Prometheus, though embodiments of the present disclosure are not so limited.

The present disclosure makes reference to specific examples of more general terms. For instance, the present disclosure makes reference to specific examples of a container orchestration system (e.g., Kubernetes), a metric store (e.g., Prometheus), a monitoring platform (e.g., vROps), metric exporters (e.g., cAdvisor, cStatsExporter, Telegraf Kubernetes Input plugin, kube-state-metrics, Windows-node-exporter, Node exporter, etc.), service instance types (e.g., node, pod, container, namespace), etc. It is noted that such reference is made for the purposes of illustration and is not intended to be taken in a limiting sense. Where specific examples are used, it is to be understood that the more general term is intended.

VROps performs Kubernetes monitoring using metrics collected by a component (e.g., a software component) known as “Adapter” (Kubernetes management pack). VROps identifies issues in a Kubernetes cluster using the metrics collected from the Adapter. The Adapter collects metrics for various Kubernetes services (e.g., nodes, pods, containers, namespaces, etc.) using a particular exporter (e.g., cadvisor) and sends those metrics to vROps where they can be displayed (e.g., in the form of one or more dashboards). However, previous approaches may support only the one exporter and are thus limited in the metrics that can be collected. Further, these approaches may support only certain types of clusters (e.g., Linux-based clusters) and may not support application metrics running in a cluster. One issue with collecting metrics from clusters is that different exporters may use different “labels” to identify the different services provided by Kubernetes. For example, cStatsExporter may use the label “pod” to refer to pods, while Telegraf Kubernetes Input plugin may use the label “pod_name” to refer to pods.

Embodiments of the present disclosure include a generic, extensible mechanism to leverage the features of multiple different exporters and provide monitoring support for different types of clusters (e.g., Windows-based clusters, Linux-based clusters, etc.) and applications running in a cluster. For instance, embodiments herein include discovering and collecting metrics from clusters using different exporters. The different labels used by the various exporters can be mapped to the services provided by Kubernetes in a mapping, which may be a configuration file, for instance. With these mappings, the metrics from each exporter can be queried from Prometheus and thereafter displayed (e.g., via vROps).

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

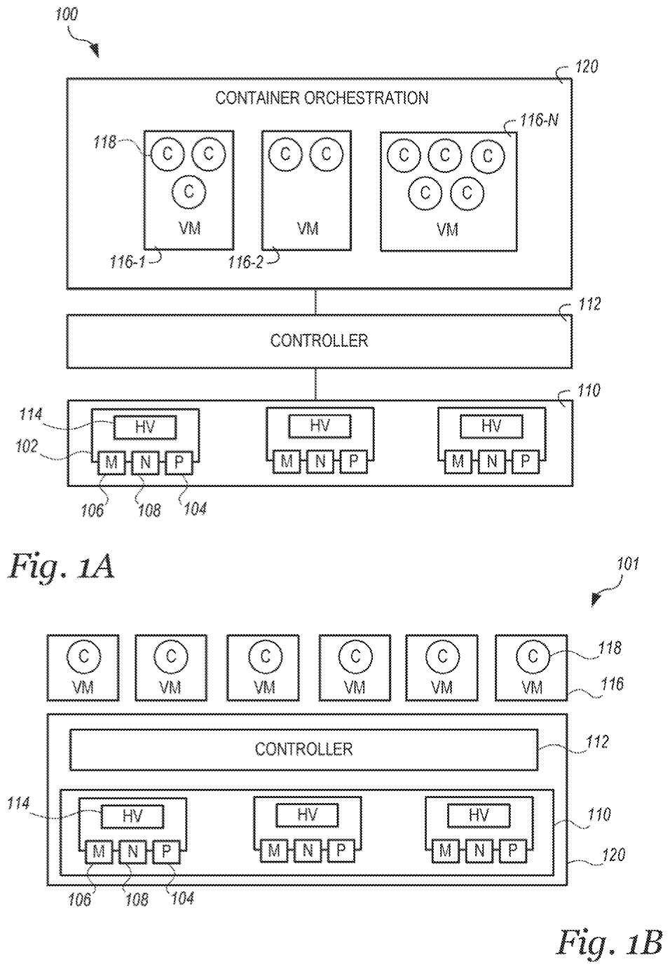

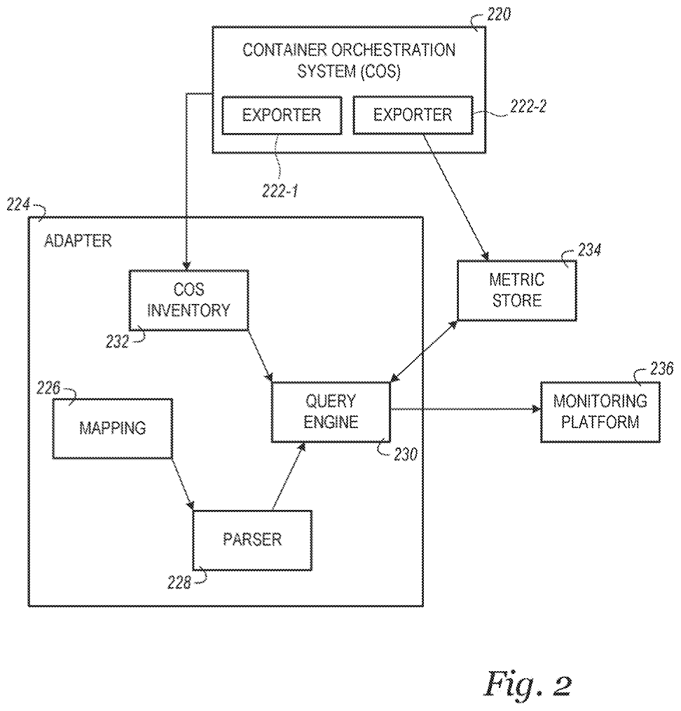

The figures herein follow a numbering convention in which the first digit or digits correspond to the drawing figure number and the remaining digits identify an element or component in the drawing. Similar elements or components between different figures may be identified by the use of similar digits. For example, 228 may reference element “28” in FIG. 2, and a similar element may be referenced as 928 in FIG. 9. Analogous elements within a Figure may be referenced with a hyphen and extra numeral or letter. Such analogous elements may be generally referenced without the hyphen and extra numeral or letter. For example, elements 116-1, 116-2, and 116-N in FIG. 1A may be collectively referenced as 116. As used herein, the designator “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1A is a diagram of an example of a container orchestration as an application in a system 100 for metric collection from a container orchestration system in accordance with a number of embodiments of the present disclosure. The system 100 can include hosts 102 with processing resources 104 (e.g., a number of processors), memory resources 106, and/or a network interface 108. The hosts 102 can be included in a software defined data center 110. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API), which can be provided by a controller 112. The hosts 102 can be in communication with the controller 112. In some embodiments, the controller 112 can be a server, such as a web server.

The hosts 102 can incorporate a hypervisor 114 that can execute a number of virtual computing instances 116-1, 116-2, . . . , 116-N (referred to generally herein as “VCIs 116”). The VCIs can be provisioned with processing resources 104 and/or memory resources 106 and can communicate via the network interface 108. The processing resources 104 and the memory resources 108 provisioned to the VCIs can be local and/or remote to the hosts 102. For example, in a software defined data center, the VCIs 116 can be provisioned with resources that are generally available to the software defined data center and not tied to any particular hardware device. By way of example, the memory resources 106 can include volatile and/or non-volatile memory available to the VCIs 116. The VCIs 116 can be moved to different hosts (not specifically illustrated), such that a different hypervisor 114 manages the VCIs 116.

In the example illustrated in FIG. 1A, the VCIs 116 are virtual machines (“VMs”) that each include a container virtualization layer to provision a number of containers 118. With respect to the virtual machines 116, the hosts 102 can be regarded as virtual machine hosts. With respect to the containers provisioned from container images provided by a virtual machine (e.g., virtual machine 116-1), the virtual machine 116 and the container virtualization layer can be regarded as a container host. In FIG. 1A, the controller 112 hosts the container orchestration system 120 (e.g., a container cluster) as an application.

FIG. 1B is a diagram of an example of integrated container orchestration in a system 101 for metric collection from a container orchestration system in accordance with a number of embodiments of the present disclosure. FIG. 1B is analogous to FIG. 1A, except that the container orchestration system 120 and the controller 112 are an embedded system. Furthermore, the virtual machines 116 can be referred to as pod virtual machines that each host a container 118. A pod is the smallest deployable unit of computing that can be created and managed by the container orchestration system 120. In contrast, in FIG. 1A, each VM 116 can provision a number of pods. In some embodiments, the container orchestration system can be a third-party system not managed by the controller 112.

FIG. 2 is a block diagram illustrating an example system for metric collection from a container orchestration system in accordance with a number of embodiments of the present disclosure. A container orchestration system (COS) 220 can manage multiple applications with shared services between the applications. The COS 220 can be responsible for application deployment, scaling, and management, such as maintenance and updates of the applications and/or services. One example of the COS 220 is Kubernetes, however, in some embodiments, the container orchestration system 220 can be implemented as described above with respect to FIG. 1A or FIG. 1B. The COS 220 can manage a container cluster.

As shown in FIG. 2, the system includes an adapter (e.g., Kubernetes adapter) that includes a mapping 226, a parser 228, a query engine 230, and a COS inventory 232. As shown, the query engine 230 is in communication with a metric store 234 and a monitoring platform 236. The COS 220 can include a first exporter 222-1 and a second exporter 222-2 (referred to cumulatively as “exporters 222”). Though the example of two exporters is discussed herein, embodiments of the present disclosure are not limited to a particular quantity of exporters. The exporters 222 can run on the COS 220 and can collect metrics associated with clusters of the COS 220. A list of example exporters can include, but is not limited to, cAdvisor, cStatsExporter, Telegraf Kubernetes Input plugin, kube-state-metrics, Windows-node-exporter, and Node Exporter. The collected metrics can be sent to the metric store 234. As previously discussed, the metric store 234 can be Prometheus, though embodiments herein are not so limited. The metric store 234 can collect and stores the metrics as time series data. Stated differently, metrics information can be stored with the timestamp at which it was recorded, alongside optional key-value pairs called labels.

Metrics can include resource usage metrics. Resource usage metrics can include service-specific utilization data for resources such as processing resources, memory resources, network resources (e.g., input/output per second (IOPS) and/or bandwidth usage), disk time, disk space, etc. Resource usage metrics can also include mathematical measures such as rate of change of resource usage, such as may be useful in a case of monotonically increasing or decreasing resources like disk space used (which tends to increase with time). More generally, metrics can include, for example, cAdvisor Metrics, cStatsExporter Metrics, Telegraf Metrics, kube-state-metrics, Windows Node Exporter Metrics, and/or Node Exporter Metrics, for instance.

The adapter (e.g., Kubernetes adapter) 224 is a component (e.g., a software component) that can fetch information about the COS 220 cluster infrastructure. This information can correspond to service instance types of the cluster, such as nodes, pods, containers, namespaces, etc., via a particular API (e.g., Kubernetes API). The information can be stored in the COS inventory 232.

More detailed metrics can be fetched by querying the metric store 234 using the query engine 230 (e.g., using PromQL). As shown in FIG. 2, multiple exporters can be deployed on the COS 220 and added as a job in the metric store 234. Multiple exporters may be used because different exporters may export different metrics and/or exhibit different features. However, each exporter provides metrics with different labels and data. Accordingly, the mapping 226 can include types of service instances provided by the COS 220 mapped to the particular labels utilized by the first exporter 222-1 and types of service instances provided by the COS 220 mapped to the particular labels utilized by the second exporter 222-2. Stated differently, the mapping can correlate the types of service instances (e.g., node, pod, container, namespace, etc.) with the labels used by the different exporters 222 for those types of service instances.

An example metric (shown below) received from the metric store 234 using Prom QL from an adapter instance during a recurring collection (e.g., every five minutes) illustrates a plurality of segments that are unique across metrics. These segments include metric_name and label name value pair:

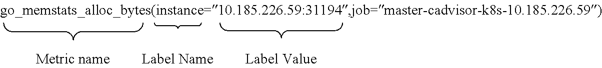

The mapping 226 (an example portion of which including mappings of two exporters is shown below) can include a heading “config_name,” which indicates the name of the exporter with a list of service instance types and their respective labels:

```
vrops_prometheus_metric_mapper: v1.0
metadata:
-prometheus_metric_model: https://prometheus.io/docs/cooncepts/data_model
# Sample metric and Format is provided below
# Prometheus Metric Format - <metric name> {<label name>=<label value>...}
# Sample Metric - Kubernetes_system_container_memory_major_page_faults
{container_name=”kubelet” , host=vrops-telegraf-k8s-fvcvr”,
# In above metric, labels/label names are container_name, host, job, namespace,
node_name
# Provide only the “LABEL NAME” below which possess id/name of Kubernetes
resources such as Node, Namespace, Pod, Container.
mapping-config:
  - config_name: cstats_exporter
    k8s_namespace:
      label_contains_name: ‘ ’
    k8s_node:
      label_contains_name: ‘node_name’
    k8s_pod:
      label_contains_name: ‘pod’
    k8s_container:
      label_contains_id: ‘id’
      label_contains_name:‘ ’
  - config_name: telegraf_exporter
    k8s_namespace:
      label_contains_name: ‘namespace’
    k8s_node:
      label_contains_name: ‘node_name’
    k8s_pod:
      label_contains_name: ‘pod_name’
    k8s_container:
      label_contains_id: ‘ ’
      label_contains_name: ‘container_name’
```

As seen, for example, in cstats_exporter, pods are labeled with ‘pod.’ In contrast, in telegraf exporter, pods are labeled with ‘pod_name.’ Below is an example of a Prometheus type metric exported by cstats exporter running on a Kubernetes cluster:

container_cpu_usage_seconds_total{beta_kubernetes_io_os=″windows″,id=″/docker/0ed
ec1e5c59cc85f7f33656a04560a18dc”, kubernetes_io_role=″node″, namespace=″kube-
system″,pod=″cstatsexporter-djfq9″} 17116.703125

In this example metric, the config_name is cstats_exporter followed by the key-value mapping of the service instance types with the labels used by the exporter to identify these service instance types in the metric exported by the exporter. The container metric exported by cstats exporter includes the container identifier with the label “id” and the pod metrics contain the pod identifier with the label “pod” so the same label is added against the service instance type in this mapping for each supported exporter.

The parser 228 can parse the information in the mapping 226 and provide the labels for each service instance type per exporter to the query engine 230. The query engine 230 can use these labels to query the metrics collected by each exporter using PromQL, for instance, though embodiments herein are not so limited. An example query can be:

query={containerLabelName=“containerNameValue from kubernetes API”}

In the above example query, the key is “containerLabelName” and the value is “containerNameValue from kubernetes API.” The containerLabelName in the above example query can be substituted with the container label provided by the parser 228 and the containerNameValue can be provided by the COS inventory 232 (e.g., Kubernetes APIs). Accordingly, for each service instance type, the query can be run for each of the exporters 222. In an example limited to containers, the following code may be illustrative:

```
for each container {
  for each exporter {
    Execute the query and store the result.
  }
}
```

Because embodiments herein can be generic to the type and/or nature of the exporters 222, support for Windows metrics can be provided by cstats exporter, telegraf exporter for Windows, etc, in contrast with previous approaches. Similarly, embodiments herein can support application metrics by using telegraf input plugins for applications, for instance.

The adapter 224 can maintain managers of each service instance type. The monitoring platform 236 can provide (e.g., display) the objects (e.g., vROps resources and/or objects) corresponding to the service instances along with the metric(s) associated therewith. Each manager can receive the metric and service information from the query engine 230, perform the generation of resource keys (e.g., vROps resource keys) for appropriate services, and add the metric(s) to resource keys. Once created, the resources can be displayed by the monitoring platform 236 along with their metric(s) (e.g., in various charts and/or dashboards).

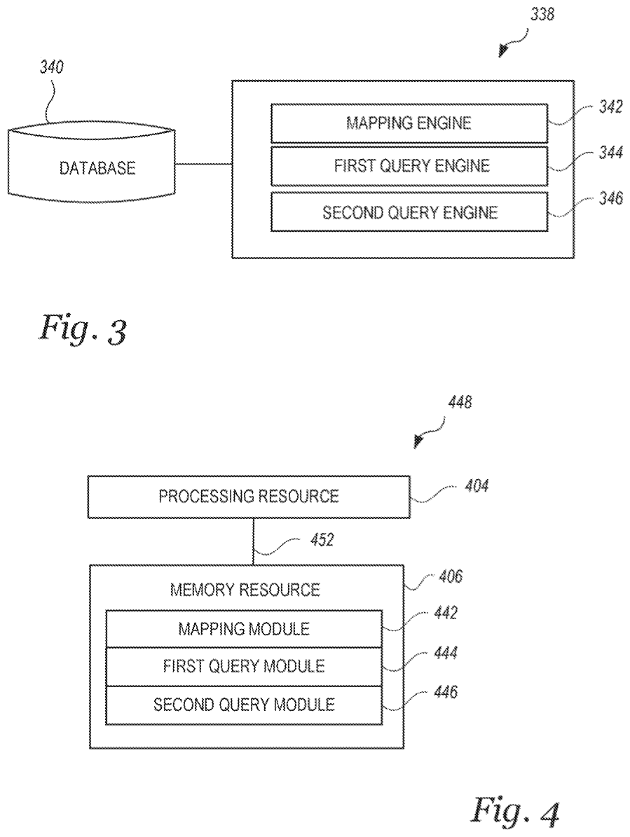

FIG. 3 is a diagram of a system 338 for metric collection from a container orchestration system according to one or more embodiments of the present disclosure. The system 338 can include a database 340 and/or a number of engines, for example mapping engine 342, first query engine 344, and/or second query engine 346, and can be in communication with the database 340 via a communication link. The system 338 can include additional or fewer engines than illustrated to perform the various functions described herein. The system can represent program instructions and/or hardware of a machine (e.g., machine 448 as referenced in FIG. 4, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware. In some embodiments, the mapping engine 342 can include a combination of hardware and program instructions that is configured to maintain a mapping. The mapping can include a plurality of types of service instances provided by a container orchestration system mapped to a first plurality of labels utilized by a first metric exporter to identify the plurality of types of service instances. The mapping can include the plurality of types of service instances provided by the container orchestration system mapped to a second plurality of labels utilized by a second metric exporter to identify the plurality of types of service instances.

In some embodiments, the first query engine 344 can include a combination of hardware and program instructions that is configured to communicate a first query for a metric associated with a particular service instance and exported by the first metric exporter, wherein the first query includes a label utilized by the first metric exporter corresponding to a type of the service instance determined based on the mapping. In some embodiments, the second query engine 346 can include a combination of hardware and program instructions that is configured to communicate a second query for the metric associated with the particular service instance and exported by the second metric exporter, wherein the second query includes a label utilized by the second metric exporter corresponding to the type of the service instance determined based on the mapping.

Some embodiments include a monitoring platform engine, which can include a combination of hardware and program instructions that is configured to determine an object corresponding to the particular service instance. In some embodiments, the monitoring platform engine can include a combination of hardware and program instructions that is configured to associate the metric with the object in a display. Some embodiments include an API engine, which can include a combination of hardware and program instructions that is configured to fetch details about a container cluster provided by the container orchestration system.

FIG. 4 is a diagram of a machine for metric collection from a container orchestration system according to one or more embodiments of the present disclosure. The machine 448 can utilize software, hardware, firmware, and/or logic to perform a number of functions. The machine 448 can be a combination of hardware and program instructions configured to perform a number of functions (e.g., actions). The hardware, for example, can include a number of processing resources 404 and a number of memory resources 406, such as a machine-readable medium (MRM) or other memory resources 406. The memory resources 406 can be internal and/or external to the machine 448 (e.g., the machine 448 can include internal memory resources and have access to external memory resources). In some embodiments, the machine 448 can be a virtual computing instance (VCI). The program instructions (e.g., machine-readable instructions (MRI)) can include instructions stored on the MRM to implement a particular function (e.g., an action such as receiving a plurality of metrics, as described herein). The set of MRI can be executable by one or more of the processing resources 404. The memory resources 406 can be coupled to the machine 448 in a wired and/or wireless manner. For example, the memory resources 406 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 406 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 404 can be coupled to the memory resources 406 via a communication path 452. The communication path 452 can be local or remote to the machine 448. Examples of a local communication path 452 can include an electronic bus internal to a machine, where the memory resources 406 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 452 can be such that the memory resources 406 are remote from the processing resources 404, such as in a network connection between the memory resources 406 and the processing resources 404. That is, the communication path 452 can be a network connection. Examples of such a network connection can include a local area network (LAN), wide area network (WAN), personal area network (PAN), and the Internet, among others.

As shown in FIG. 4, the MRI stored in the memory resources 406 can be segmented into a number of modules 442, 444, 446 that when executed by the processing resources 404 can perform a number of functions. As used herein a module includes a set of instructions included to perform a particular task or action. The number of modules 442, 444, 446 can be sub-modules of other modules. For example, the second query module 446 can be a sub-module of the first query module 444 and/or can be contained within a single module. Furthermore, the number of modules 442, 444, 446 can comprise individual modules separate and distinct from one another. Examples are not limited to the specific modules 442, 444, 446 illustrated in FIG. 4.

Each of the number of modules 442, 444, 446 can include program instructions and/or a combination of hardware and program instructions that, when executed by a processing resource 404, can function as a corresponding engine as described with respect to FIG. 3. For example, the mapping module 442 can include program instructions and/or a combination of hardware and program instructions that, when executed by a processing resource 404, can function as the mapping engine 336, though embodiments of the present disclosure are not so limited. The machine 448 can include a mapping module 442, which can include instructions to maintain a mapping. The mapping can be a configuration file. The mapping can be referred to as a “YAML.” The mapping can include a plurality of types of service instances provided by a container orchestration system (e.g., an open-source container orchestration system) mapped to a first plurality of labels utilized by a first metric exporter to identify the plurality of types of service instances. The mapping can include the plurality of types of service instances provided by the container orchestration system mapped to a second plurality of labels utilized by a second metric exporter to identify the plurality of types of service instances. The machine 448 can include a first query module 444, which can include instructions to communicate a first query for a metric associated with a particular service instance and exported by the first metric exporter, wherein the first query includes a label utilized by the first metric exporter corresponding to a type of the service instance determined based on the mapping. The machine 448 can include a second query module 446, which can include instructions to communicate a second query for the metric associated with the particular service instance and exported by the second metric exporter, wherein the second query includes a label utilized by the second metric exporter corresponding to the type of the service instance determined based on the mapping.

In some embodiments, the machine 448 includes instructions to receive and store the metric exported by the first metric exporter and the metric exported by the second metric exporter. In some embodiments, the machine 448 includes instructions to communicate the first query and the second query to a metric store. The metric store can be an open-source systems and service monitoring system

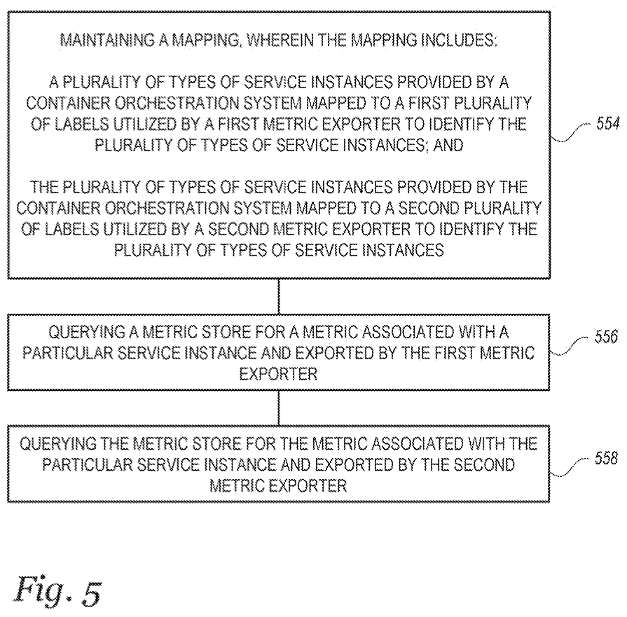

FIG. 5 illustrates a method of metric collection from a container orchestration system according to one or more embodiments of the present disclosure. At 554, the method includes maintaining a mapping, wherein the mapping includes a plurality of types of service instances provided by a container orchestration system mapped to a first plurality of labels utilized by a first metric exporter to identify the plurality of types of service instances, and the plurality of types of service instances provided by the container orchestration system mapped to a second plurality of labels utilized by a second metric exporter to identify the plurality of types of service instances.

At 556, the method includes querying a metric store for a metric associated with a particular service instance and exported by the first metric exporter. At 558, the method includes querying the metric store for the metric associated with the particular service instance and exported by the second metric exporter. In some embodiments, querying the metric store for the metric associated with the particular service instance and exported by the first metric exporter includes communicating a label utilized by the first metric exporter corresponding to a type of the service instance determined based on the mapping. In some embodiments, querying the metric store for the metric associated with the particular service instance and exported by the second metric exporter includes communicating a label utilized by the second metric exporter corresponding to the type of the service instance determined based on the mapping.

In some embodiments, the method includes displaying the metric in association with an object corresponding to the particular instance in a monitoring platform. In some embodiments, the mapping includes the plurality of types of service instances provided by the container orchestration system mapped to a third plurality of labels utilized by a third metric exporter to identify the plurality of types of service instances, and wherein the method includes querying the metric store for the metric associated with the particular service instance and exported by the third metric exporter. In some embodiments, the method includes querying the metric store for the metric associated with the particular service instance and exported by the first metric exporter and querying the metric store for the metric associated with the particular service instance and exported by the second metric exporter using PromQL. In some embodiments, the metric is an application metric.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A non-transitory machine-readable medium having instructions stored thereon which, when executed by a processor, cause the processor to:
maintain a mapping, wherein the mapping includes:
a plurality of types of service instances provided by a container orchestration system mapped to a first plurality of labels utilized by a first metric exporter to identify the plurality of types of service instances; and
the plurality of types of service instances provided by the container orchestration system mapped to a second plurality of labels utilized by a second metric exporter to identify the plurality of types of service instances;
communicate a first query for a metric associated with a particular service instance and exported by the first metric exporter, wherein the first query includes a label utilized by the first metric exporter corresponding to a type of the service instance determined based on the mapping; and
communicate a second query for the metric associated with the particular service instance and exported by the second metric exporter, wherein the second query includes a label utilized by the second metric exporter corresponding to the type of the service instance determined based on the mapping.

2. The medium of claim 1, including instructions to receive and store the metric exported by the first metric exporter and the metric exported by the second metric exporter.

3. The medium of claim 1, wherein the plurality of types of service instances include:
node;
pod;
container; and
namespace.

4. The medium of claim 1, wherein the instructions to communicate the first query and the second query include instructions to communicate the first query and the second query to a metric store.

5. The medium of claim 4, wherein the metric store is an open-source systems and service monitoring system.

6. The medium of claim 1, wherein the container orchestration system is an open-source container orchestration system.

7. The medium of claim 1, wherein the mapping is a configuration file.

8. The medium of claim 7, wherein the mapping is in a YAML language.

9. A system, comprising:
a mapping engine configured to maintain a mapping, wherein the mapping includes:
a plurality of types of service instances provided by a container orchestration system mapped to a first plurality of labels utilized by a first metric exporter to identify the plurality of types of service instances; and
the plurality of types of service instances provided by the container orchestration system mapped to a second plurality of labels utilized by a second metric exporter to identify the plurality of types of service instances;
a first query engine configured to communicate a first query for a metric associated with a particular service instance and exported by the first metric exporter, wherein the first query includes a label utilized by the first metric exporter corresponding to a type of the service instance determined based on the mapping; and
a second query engine configured to communicate a second query for the metric associated with the particular service instance and exported by the second metric exporter, wherein the second query includes a label utilized by the second metric exporter corresponding to the type of the service instance determined based on the mapping.

10. The system of claim 9, including a monitoring platform engine configured to determine an object corresponding to the particular service instance.

11. The system of claim 10, wherein the monitoring platform engine is configured to associate the metric with the object in a display.

12. The system of claim 9, including an application programming interface (API) engine configured to fetch details about a container cluster provided by the container orchestration system.

13. The system of claim 12, wherein the particular service instance is one of:
a particular node of the container cluster;
a particular pod of the container cluster;
a particular container of the container cluster; and
a particular namespace of the container cluster.

14. A method, comprising:
maintaining a mapping, wherein the mapping includes:
a plurality of types of service instances provided by a container orchestration system mapped to a first plurality of labels utilized by a first metric exporter to identify the plurality of types of service instances; and
the plurality of types of service instances provided by the container orchestration system mapped to a second plurality of labels utilized by a second metric exporter to identify the plurality of types of service instances;
querying a metric store for a metric associated with a particular service instance and exported by the first metric exporter; and
querying the metric store for the metric associated with the particular service instance and exported by the second metric exporter.

15. The method of claim 14, wherein querying the metric store for the metric associated with the particular service instance and exported by the first metric exporter includes communicating a label utilized by the first metric exporter corresponding to a type of the service instance determined based on the mapping.

16. The method of claim 15, wherein querying the metric store for the metric associated with the particular service instance and exported by the second metric exporter includes communicating a label utilized by the second metric exporter corresponding to the type of the service instance determined based on the mapping.

17. The method of claim 14, wherein the method includes displaying the metric in association with an object corresponding to the particular instance in a monitoring platform.

18. The method of claim 14, wherein the mapping further includes the plurality of types of service instances provided by the container orchestration system mapped to a third plurality of labels utilized by a third metric exporter to identify the plurality of types of service instances, and wherein the method includes querying the metric store for the metric associated with the particular service instance and exported by the third metric exporter.

19. The method of claim 14, wherein the method includes querying the metric store for the metric associated with the particular service instance and exported by the first metric exporter and querying the metric store for the metric associated with the particular service instance and exported by the second metric exporter using Prometheus query language (PromQL).

20. The method of claim 14, wherein the metric is an application metric.
